(19) United States
(12) Patent Application Publication
(10) Pub. No.: US 2023/0295967 A1
(43) Pub. Date: Sep. 21, 2023

(54) COVER OPENING AND CLOSING DEVICE USING SLIDING AND ROTATION

(71) Applicants: SAMKWANGWINTECH CO., LTD., Gyeongsan-si (KR); MULTIPATH CO., LTD, Suwon-si (KR); DBK.CO.LTD, Uiwang-si (KR)

(72) Inventors: Yoo Hee KUK, Suwon-si (KR); Lee Jeong YONG, Hwaseong-si (KR)

(73) Assignees: SAMKWANGWINTECH CO., LTD., Gyeongsan-si (KR); MULTIPATH CO., LTD, Suwon-si (KR); DBK.CO.LTD, Uiwang-si (KR)

(21) Appl. No.: 18/098,751

(22) Filed: Jan. 19, 2023

(30) Foreign Application Priority Data
Mar. 21, 2022 (KR) 10-2022-0034598

(51) Int. Cl. E05C 19/02; E05B 83/28

(52) U.S. Cl. CPC E05C 19/022; E05B 83/28

(57) ABSTRACT

A cover slides to protrude outward from a mounted position. At the same time, the cover may rotate to be opened, and thus a gap between the cover and an inlet portion on which the cover is mounted is minimized. The cover may be opened or closed easily and conveniently without degrading a sense of beauty and aesthetics at the portion on which the cover is mounted. The cover is caught and locked by a push latch. The cover may slide and rotate by being easily unlocked when being pressed by a hand. A user may easily and conveniently use the cover by a simple operation of pressing the cover. A sudden rotation of the cover is prevented using an elastic support member and a damper, and thus the cover can be conveniently used even while an occurrence of noise or collision between the cover and surroundings is prevented.

### CROSS-REFERENCE TO RELATED APPLICATION

This application claims priority to and the benefit of Korean Patent Application No. 10-2022-0034598 filed on Mar. 21, 2022, the disclosure of which is incorporated herein by reference in its entirety.

### BACKGROUND OF THE INVENTION

### 1. Field of the Invention

The present disclosure relates to a cover opening and closing device using sliding and rotation, and more particularly, to a cover opening and closing device in which, since a cover is configured to slide and protrude outward to rotate, a gap between the cover and a cover entrance when the cover is closed, particularly, a gap formed so that the cover rotates, is eliminated, and the cover and a surrounding thereof are integrated into like one component, and thus a sense of beauty and aesthetics at a place on which the cover is mounted can be improved even while a sense of unity is provided.

### 2. Discussion of Related Art

In general, a rotating body (or a cover) that may be opened or closed is mounted on a container or storage box to prevent intrusion of foreign substances and improve outer appearance, a sense of beauty, and aesthetics. This rotating body may be opened or closed in various manners as exemplified in the interior of a vehicle as in (Patent Document 1) to (Patent Document 3).

Patent Document 1: Korean Patent No. 10-1307065

A cover locking device for a tray of a vehicle includes a housing for accommodating items, a cover that is rotatably installed in the front of the housing and seals a front opening of the housing, a rotary rotatably installed on one side of the cover, a rotary spring that is coupled to the rotary and prevent a sag of the rotary due to gravity, a rotary cap that is installed on one side of the rotary and prevents the rotary from being in direct contact with a screw to improve operability of the rotary, a rotary pin that is installed in the rotary and moves along a heart rail of a double heart cam provided in the housing, and a screw fastening the rotary and the cover, wherein since a locking state of the cover may be continuously maintained even when an external impact is applied to the cover while the vehicle is traveling, the items inside the housing may be prevented from spilling out when the cover is opened while the vehicle travels, and thus safety of the vehicle can be greatly improved.

Patent Document 2: Korean Patent No. 10-1923499

A fastening unit of a keyhole cover for a door lock assembly of a vehicle is disclosed. Accordingly, the fastening unit of the keyhole cover for a door lock assembly of a vehicle includes a button insertion part that has a space part formed on one side of a door lock body of the door lock assembly and has slots formed in a front surface and a rear surface thereof and having a predetermined length, a push button in which a hook is integrally formed at a tip of a hook bridge formed to face an inside at a center of each of a front surface and a rear surface so that the push button acts on a button hole formed in the keyhole cover, a protrusion end is integrally formed on one side thereof, and a spring guider is integrally formed at a center of an inner surface thereof, is inserted into the button insertion part, and is assembled by catching each hook in each slot, and a spring fitted in the spring guider to providing an elastic force to the push button from an inside of the button insertion part.

Patent Document 3: Korean Patent No. 10-0666364

The present document relates to a locking device for a two-stage center console of a vehicle, and particularly, to a device for limiting opening of a first stage lid when a second stage lid is opened by improving a locking device for a two-stage center console provided in the vehicle, the device including a console body that is fixed to a floor panel of the vehicle and has a second accommodation space open upward therein, a second lid that is rotatably supported by the console body to open or close an opening of the second accommodation space and has a first accommodation space open upward therein, a first lid rotatably supported by the second lid to open or close an opening of the first accommodation space, a first lever that is positioned on an inner front side of the first lid, is elastically supported so that the first lever is rotated in one direction by an elastic body, and controls opening and closing of the first lid, and a second lever that is positioned in an inner front side of the second lid, is elastically supported so that the second lever is rotated in the one direction by the elastic body, controls opening and closing of the second lid, and restricting release of the first lever when the second lid is open, items accommodated in the first accommodation space of the second lid are prevented from being spilling out, and thus convenience and safety of the user can be improved.

### PATENT DOCUMENTS

(Patent Document 1) Korean Patent No. 10-1307065 (registered on Sep. 4, 2013)

(Patent Document 2) Korean Patent No. 10-1923499 (registered on Dec. 7, 2018)

(Patent Document 3) Korean Patent No. 10-0666364 (registered on Jan. 3, 2007)

### SUMMARY OF THE INVENTION

However, a rotating body such as the conventional cover has the following problems.

(1) In order to rotate a portion that is a rotational center of a rotating body without being caught in an inlet portion in which the rotating body is installed, a long groove is formed around the rotational center of the rotating body when the rotating body is closed.

(2) That is, since an edge that is the rotational center of the rotating body is generally formed in a rounded shape, the rounded portion is not caught by the inlet portion in which the rotating body is installed when the rotating body is opened through rotation, and thus the rotating body is rotatably manufactured. Accordingly, a long groove for preventing rotational interference from occurring between the rotating body and the inlet portion for installing the rotating body is formed.

(3) The groove has a sense of beauty and aesthetics as if the groove was separated without providing a sense of unity with a surface on which the rotating body is mounted.

(4) In particular, the rotating body installed in a limited space such as a space in a vehicle acts as a factor that greatly degrades the sense of beauty and the aesthetics of an interior of the vehicle as a circumference of the rotating body is surrounded by the groove.

(5) Further, since various rotating bodies, such as glove boxes, center fasciae, and armrests, used in a rotating manner in a limited space, are installed in such a narrow space, the sense of beauty and the aesthetics of the interior of the vehicle can be further improved.

The present disclosure is directed to providing a cover opening and closing device using sliding and rotation, in which a cover slides to protrude outward from a mounted position, and then, the cover may be opened through rotation, and thus a gap between the cover and an inlet portion on which the cover is mounted is minimized, and the cover may be opened or closed easily and conveniently without degrading a sense of beauty and aesthetics at the portion on which the cover is mounted.

The present disclosure is directed to also providing a cover opening and closing device using sliding and rotation, in which the cover is caught and locked by a push latch, the cover may slide and rotate by being easily unlocked when being pressed by a hand, and thus a user may easily and conveniently use the cover by a simple operation of pressing the cover.

The present disclosure is directed to also providing a cover opening and closing device using sliding and rotation, in which a sudden rotation of the cover is prevented using an elastic support member and a damper, and thus the cover can be conveniently used even while an occurrence of noise or collision between the cover and surroundings is prevented.

A cover opening and closing device includes a support block (100) having a guide hole (110) and a mounting hole (120) formed therein, a rotation support part (200) mounted in the guide hole (110), a push latch (300) installed in the mounting hole (120), and a cover (400) is rotated by being supported by the rotation support part (200) and has a stopper (410) that is caught/released by the push latch (300), wherein the rotation support part (200) includes a guide (210) that is fitted in the guide hole (110), slides in a longitudinal direction thereof, and has a reaction part (212) pressed by a first rotation link (220), which will be described below, when the cover (400) is closed and configured to provide an elastic force so that the first rotation link (220) is bounced when the cover (400) is opened, the first rotation link (220) that is installed in the guide (210) so that one side thereof rotates in place, extends in the longitudinal direction and is long so as to be installed in close contact with the cover (400) that in a closed state, and has one side installed to be elastically supported by an elastic support member (221) supported by the guide hole (110) so as to rotate outside the guide hole (110), a second rotation link (230) that has one side installed in a middle of a length of the first rotation link (220) to rotate in place and the other side installed in the cover (400) to rotate in place and is installed to rotate in a direction opposite to the first rotation link (220) based on a point at which the first rotation link (220) is installed, a third rotation link (240) that has one side installed between a point at which the first rotation link (220) is rotatably mounted on the guide (210) and a point at which the second rotation link (230) is installed to rotate in place and the other side installed in the cover (400) to rotate in place and is installed to rotate in a direction opposite to the first rotation link (220) based on a point at which the first rotation link (220) is installed, and a fourth rotation link (250) that has one side installed in a central portion of the third rotation link (240) to rotate in palace and the other side installed in the guide (210) to rotate in place and is installed to rotate in the same direction as the first rotation link (220) based on a point mounted on the guide (210) so as to change a rotational direction of the third rotation link (240) that rotates based on the first rotation link (220).

A guide groove (130) may be formed through the support block (100) and may be long to pass through the guide hole (110) in the longitudinal direction, and the guide (210) may be provided with at least one guide pin (211) guided through the guide groove (130).

The guide (210) may have at least one idle roller that rolls in close contact with an inner surface of the guide hole (110).

The rotation support part (200) may be equipped with a damper (260) that limits a sudden rotation of the first rotation link (220) by performing a buffering operation in a direction opposite to an elastic direction of the elastic support member (221).

The fourth rotation link (250) may be mounted on the guide (210) so as to be positioned further outward from at a position that laterally deviates from a rotation center point of the first rotation link (220) based on a direction in which the guide (210) slides.

The rotation support part (200) may cause the cover (400) to rotate in the angle of 90°˜110° from the close position.

### BRIEF DESCRIPTION OF THE DRAWINGS

The above and other objects, features and advantages of the present disclosure will become more apparent to those of ordinary skill in the art by describing exemplary embodiments thereof in detail with reference to the accompanying drawings, in which:

FIG. 1 is a perspective view illustrating an example in which a cover opening and closing device using sliding and rotation according to the present disclosure is applied to a cigar jack;

FIG. 2 is an exploded perspective view illustrating the example in which the cover opening and closing device using sliding and rotation according to the present disclosure is applied to the cigar jack;

FIG. 3 is an exploded perspective view, in which a portion of the cover opening and closing device using sliding and rotation according to the present disclosure is separated to show a configuration thereof;

FIG. 4 is a schematic view illustrating a state in which the cover opening and closing device using sliding and rotation according to the present disclosure is closed;

FIG. 5 is a perspective view illustrating a coupled state of a rotation link constituting a rotary support part according to the present disclosure;

FIG. 6 is a schematic view illustrating a state in which the cover opening and closing device using sliding and rotation according to the present disclosure is opened; and

FIGS. 7 to 9 are schematic views illustrating a process in which the cover opening and closing device using sliding and rotation in a closed state according to the present disclosure is opened.

### DETAILED DESCRIPTION OF THE INVENTION

Hereinafter, exemplary embodiments of the present disclosure will be described in more detail with reference to the accompanying drawings. Prior to this, terms or words used in the present specification and the appended claims should not be interpreted as being limited to usual or dictionary meanings and should be interpreted as meanings and concepts corresponding to the technical spirit of the present disclosure according to the principle that the inventor may properly define the concepts of the terms in order to describe his/her own invention in the best way.

Thus, since the embodiments described in the present specification and configurations illustrated in the drawings are merely the most exemplary embodiments of the present disclosure and do not represent all the technical spirit of the present disclosure, it should be understood that various equivalents and variations that may replace the embodiments and the configurations are present at filling of the present application.

Configuration of Cover Opening and Closing Device

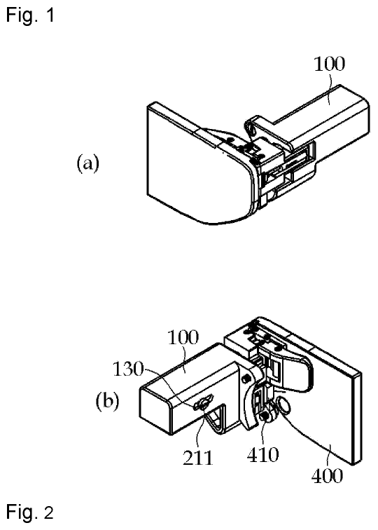

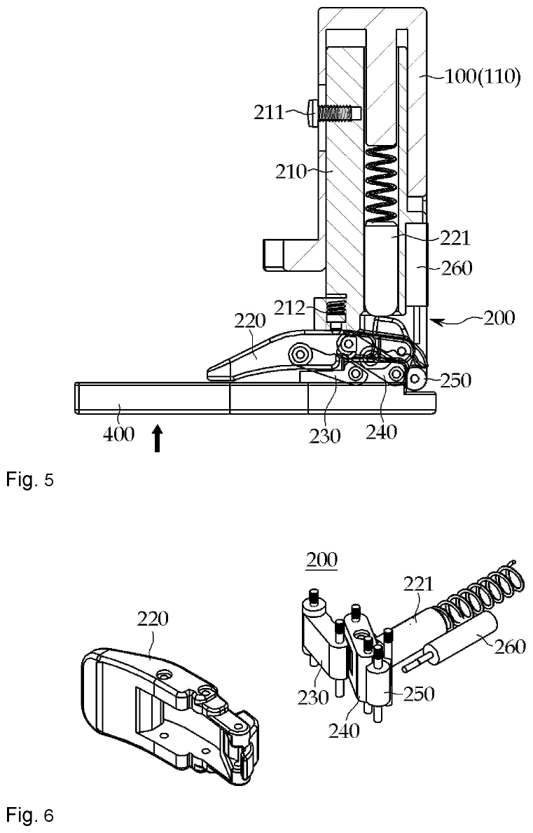

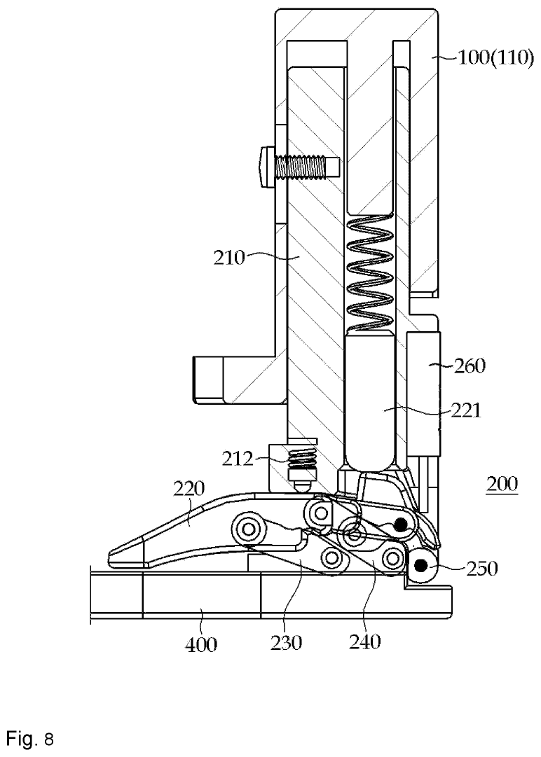

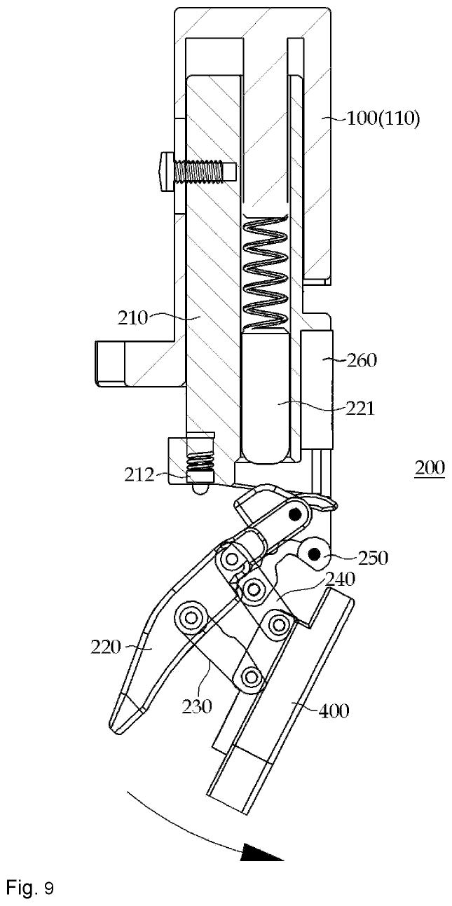

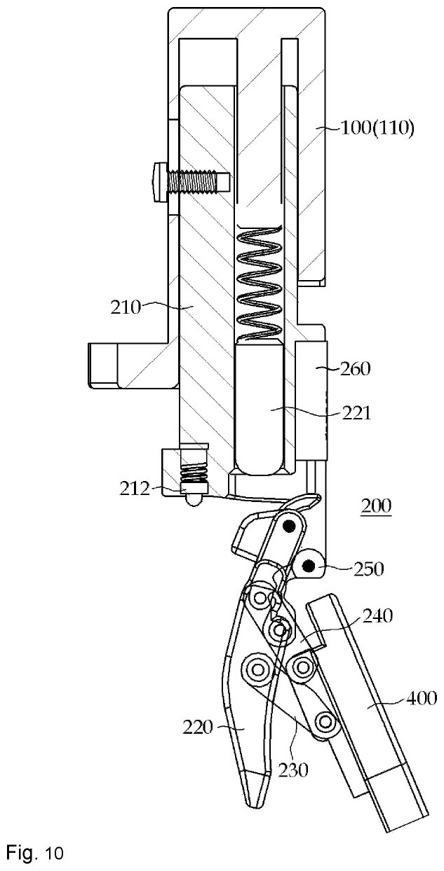

As illustrated in FIGS. 1 to 9, a cover opening and closing device using sliding and rotation according to the present disclosure includes a support block 100, a rotation support part 200, a push latch 300, and a cover 400.

In particular, since the cover 400 is opened or closed by being rotated through the rotation support part 200 in a state of protruding outward from a position in which the cover 400 is mounted, a gap between the cover 400 and an inlet portion on which the cover 400 is mounted is minimized, and thus a sense of beauty and aesthetics can be improved even while a sense of unity is provided.

In this case, the cover 400 is configured to maintain a closed state using the push latch 300, and thus the cover 400 may be easily opened or closed by a simple operation of pressing the cover 400 with a hand or the like.

Hereinafter, these configurations will be described in more detail with reference to the accompanying drawings. In the drawings, a pin portion indicated by a black circle indicates a portion fixed to rotate in place, and a pin portion indicated by a hollow circle indicates a portion in which a link rotates while moving.

A. Support Block

As illustrated in FIGS. 1 to 3, the support block 100 is a block assembled in a mounting member, on which the cover 400 to be described below will be mounted and finished, in the form of a module. It is preferable that the support block 100 is easily assembled in a manner in which the support block 100 is assembled by being forcibly fitted into the mounting member, a manner in which the support block 100 is assembled in a one-touch assembly method, or a manner in which the support block 100 is fixedly fastened using a screw or the like.

As illustrated in FIGS. 2 to 4, a guide hole 110 and a mounting hole 120 are formed in the support block 100. Further, a guide groove 130 is additionally formed in an outer side of the support block 100.

1. Guide Hole

As illustrated in FIG. 2, the guide hole 110 is a hole for guiding a guide 210 of the rotation support part 200, which will be described below, such that the guide 210 may slide in a longitudinal direction. Accordingly, a cross section of the guide hole 110 is formed in a shape of a cross section of the guide 210, and thus the rotation support part 200 is accommodated or extracted in a longitudinal direction of the guide hole 110.

2. Mounting Hole

As illustrated in FIG. 2, the mounting hole 120 is a hole on which the push latch 300, which will be described below, is to be mounted. Here, the push latch 300 is a type of stopper that keeps the cover 400 in a closed state when the cover 400 is closed, and a description thereof will be made below.

3. Guide Groove

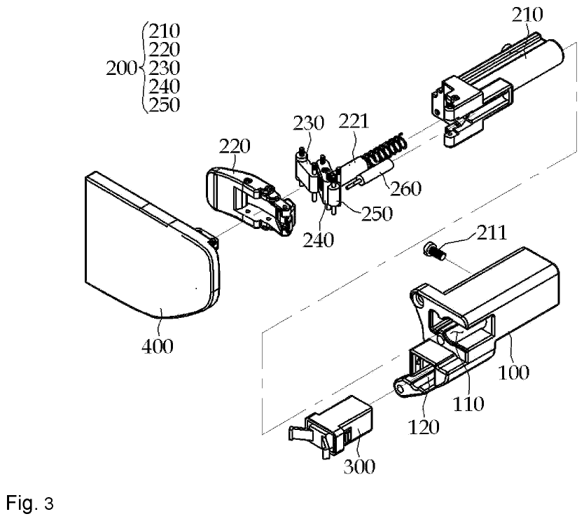

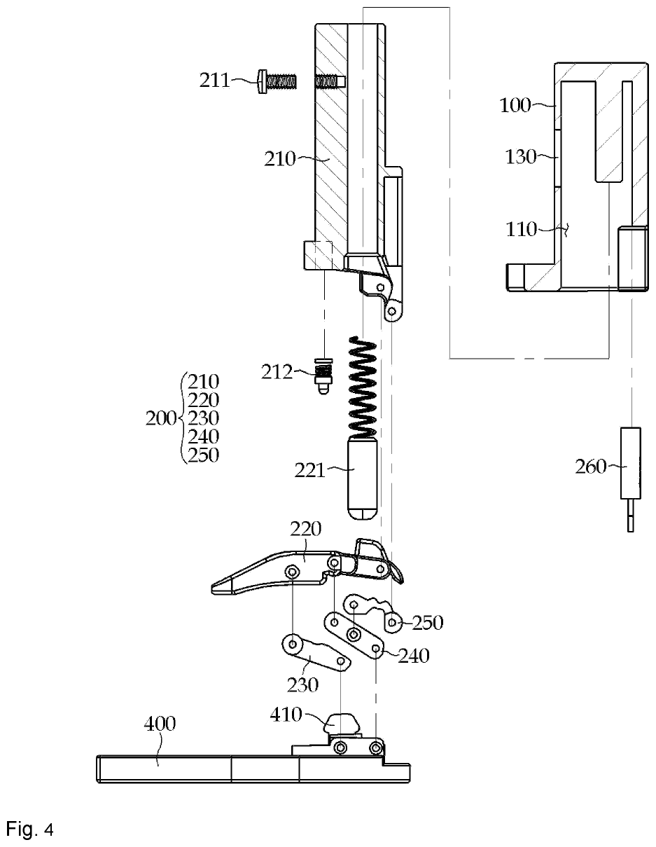

As illustrated in FIGS. 3 and 4, the guide groove 130 is formed in the support block 100. In this case, since the guide groove 130 is formed to be elongated parallel to the guide hole 110 and communicate with the guide hole 110, a guide pin 211 fitted through the guide groove 130 is fastened to the guide 210, and thus the guide 210 is guided to slidably reciprocate within a longitudinal length of the guide groove 130 while being prevented from rotating.

B. Rotation Support part

As illustrated in FIGS. 2 to 6, the rotation support part 200 is fitted in the guide hole 110, slides in the longitudinal direction of the guide hole 110 to allow the cover 400, which will be described below, to protrude outward from a cover mounting position, and then rotates in place to open the cover 400. Thus, even when there is no gap between the cover 400 and the inlet portion on which the cover 400 is mounted, the cover 400 can be opened and closed without rotational interference.

As illustrated in FIGS. 2 to 6, the rotation support part 200 includes the guide 210, a first rotation link 220, a second rotation link 230, a third rotation link 240, and a fourth rotation link 250. Further, a damper 260 may be additionally formed in the rotation support part 200.

1. Guide

As illustrated in FIGS. 2 to 4 and 6, the guide 210 is inserted into the guide hole 110 and is mounted to be movable in a longitudinal direction thereof. In this case, the guide 210 receives an elastic force of an elastic support member 221 elastically supporting the first rotation link 220, which is rotatably installed therein and will be described below, and slides inside the guide hole 110.

In particular, in exemplary embodiments of the present disclosure, as illustrated in FIGS. 3, 4, and 6, it is preferable that the guide pin 211 that is mounted by being fitted to pass through the guide groove 130 be additionally configured. This is for guiding the guide pin 211 so that the guide pin 211 may slide within a predetermined route and range as the guide pin 211 moves along the guide groove 130.

Further, in exemplary embodiments of the present disclosure, although not illustrated, it is preferable that at least one idle roller be mounted on the guide 210 and be in close contact with an inner surface of the guide hole 110 to minimize frictional resistance so that a smooth sliding operation may be performed. The number and mounting positions of these idle rollers are appropriately selected so that a load is distributed in consideration of a weight, a center of gravity, and an entire length to achieve the smooth sliding operation.

Meanwhile, as illustrated in FIGS. 3, 4 and 6, a reaction part 212 is mounted on the guide 210. The reaction part 212 receives interference from the first rotation link 220, which will be described below, to store an elastic force, when the cover 400, which will be described below, is closed, and allows the first rotation link 220 to be easily rotated using the stored elastic force, conversely, when the cover 400 is opened, and to rotate the cover 400 outward, thereby performing a smooth opening operation.

2. First Rotation Link

As illustrated in FIGS. 3, 4, and 6, one side of the first rotation link 220 is mounted on the guide 210 to rotate in place. In this case, the first rotation link 220 is elastically supported by the elastic support member 221 installed in the guide hole 110 and thus rotates outward. Here, the elastic support member 221 is elastically supported by a spring fitted in the guide hole 110 so that one side of the elastic support member 221 supports the first rotation link 220 to rotate outward. In this way, as the first rotation link 220 rotates, an elastic force is provided even to the guide 210, in which the first rotation link 220 is installed, so that the guide 210 slides in the guide hole 110 in the longitudinal direction. An example of a case in which the elastic support member 221 is installed to elastically support the first rotation link 220 within the guide 210 so that the first rotation link 220 may be elastically supported to rotate outward is illustrated in the drawings.

In this case, as illustrated in FIGS. 1B, 3, and 4, the first rotation link 220 extends outward and is long in a state of being mounted on the guide 210 to rotate in place and is formed in contact with a surface of the cover 400 when the cover 400, which will be described below, is closed. This is for easily opening the cover 400 by pressing and unfolding the first rotation link 220 as much as the cover 400 rotates as a force transmitted to the cover 400 is efficiently transmitted to the first rotation link 220 in contact with the cover 400 when the cover 400 is pressed from the outside to open the cover 400.

This is for easily and quickly rotating the first rotation link 220 because the first rotation link 220 is in close contact with the cover 400, which will be described below, when the first rotation link 220 rotates.

3. Second Rotation Link

As illustrated in FIGS. 3 to 6, one side of the second rotation link 230 is installed in the middle of a length of the first rotation link 220 to rotate in place, and the other side thereof is mounted on the cover 400, which will be described below, to rotate in place.

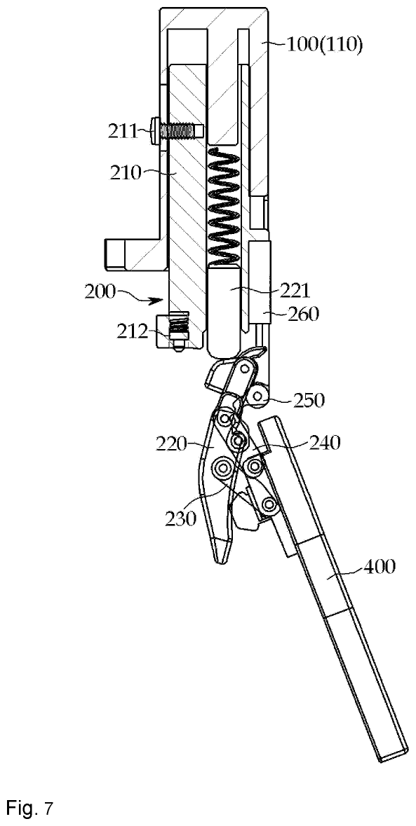

In this case, as illustrated in FIGS. 7 to 9, the second rotation link 230 is mounted to rotate in a direction opposite to the first rotation link 220 based on a point at which the second rotation link 230 is rotatably supported by the first rotation link 220, and thus the cover 400 together with the third rotation link 240 is opened while being pushed outward from the closed state.

4. Third Rotation Link

As illustrated in FIGS. 3 to 6, one side of the third rotation link 240 is mounted on the first rotation link 220 between a point at which the first rotation link 220 is mounted on the guide 210 and a point at which the second rotation link 230 is mounted, and the other side thereof is mounted on the cover 400 to rotate in place. In this case, the third rotation link 240 is installed to rotate in a direction opposite to the first rotation link 220 based on a point at which the third rotation link 240 is rotatably installed in the first rotation link 220. Accordingly, the second rotation link 230 and the third rotation link 240 rotate in place between the first rotation link 220 and the cover 400 in the form of a four-bar linkage, and the cover 400 may be opened to the outside.

5. Fourth Rotation Link

As illustrated in FIGS. 3 to 6, one side of the fourth rotation link 250 is mounted on the guide 210 to rotate in place, and the other side thereof is mounted in the middle of a length of the third rotation link 240 to rotate in place. Thus, the fourth rotation link 250 is installed to rotate about the guide 210 in the same direction as the first rotation link 220.

In particular, as illustrated in FIGS. 7 to 9, the fourth rotation link 250 rotates in the same direction as the first rotation link 220 as the cover 400 is opened, and the rotating third rotation link 240 rotates in an opposite direction based on the first rotation link 220. Thus, while the second rotation link 230 and the third rotation link 240 rotate in a direction in which the second rotation link 230 and the third rotation link 240 face each other based on the first rotation link 220, an open position of the cover 400, which will be described below, may be fixed.

In exemplary embodiments of the present disclosure, as illustrated in FIGS. 7 to 9, the fourth rotation link 250 deviates to a lateral side from a point at which the first rotation link 220 is fixed to the guide 210 to rotate in place based on the sliding direction of the guide 210. As the fourth rotation link 250 is mounted on the guide 210 to rotate in place at a position protruding further outward from the lateral deviation point, the first rotation link 220, the third rotation link 240, and the fourth rotation link 250 are connected in the form of a four-bar linkage, and thus the cover 400 may be stably opened or closed by a desired angle.

6. Damper

As illustrated in FIGS. 3 to 6, the damper 260 is additionally configured in the rotation support part 200 and is preferably mounted on the guide 210. In this case, the damper 260 is installed to be elastically supported by the elastic support member 221 so as to prevent rapid rotation of the first rotation link 220 that is to rotate outward. Accordingly, the damper 260 buffers and supports the first rotation link 220 in a direction opposite to an elastic support direction of the elastic support member 221.

The rotation support part 200 according to the present disclosure made in this way may variously adjust an opening angle of the cover 400 according to lengths and connection positions of these rotation links, and it is best to manufacture the cover 400 that is opened at the opening angle of 90° to 110°, and more preferably, 100°.

C. Push Latch

As illustrated in FIG. 2, the push latch 300 is mounted on the mounting hole 120. In this case, a technique manufactured by a conventional technique in which the push latch 300 maintains the cover 400 closed as a stopper 410 formed in the cover 400 is caught when the cover 400, which will be described below, is located in a closed position, and the cover 400 may rotate as the stopper 410 is unlocked from the push latch 300 when the cover 400 in a closed state is pressed with a hand or the like is used.

D. Cover

As illustrated in FIGS. 2, 3, and 6, the cover 400 is rotatably mounted on the rotation support part 200. The cover 400 has the stopper 410 that is caught by the push latch 300 in a closed state and releases the catching when the cover 400 is pressed.

In this case, as illustrated in FIGS. 7 to 9, the cover 400 is mounted on sides of the second rotation link 230 and the third rotation link 240 to rotate in place, and thus the first rotation link 220, the second rotation link 230, the cover 400, and the third rotation link 240 are connected in the form of a four-bar linkage to perform an opening and closing operation through rotation.

As illustrated in FIGS. 4 and 7, when the cover 400 made in this way in a closed state is pressed in an arrow direction and then the pressing force is removed, the catching of the cover 400 is released from the push latch 300. As illustrated in FIGS. 6, 8, and 9, accordingly, while the guide 210 elastically supported by the elastic support member 221 protrudes from the support block 100, the links rotate, and thus the cover 400 is rotated at a predetermined angle and is opened.

A cover opening and closing device using sliding and rotation according to the present disclosure has the following effects.

(1) Since a cover is opened through rotation in a state in which the cover slides outward from a mounted position, a gap between the cover and an inlet portion on which the cover is mounted can be minimized.

(2) This can improve a sense of unity, a sense of beauty, and aesthetics as the cover and a position on which the cover is mounted seem like one component.

(3) Further, since the cover is opened or closed using various rotation links that rotate in the form of a four-bar linkage, the cover can be easily manufactured at an angle at which the cover is opened according to lengths of the rotation links.

(4) Since the cover is configured so as not to suddenly close or open using an elastic support member and a damper, the cover is naturally opened or closed.

(5) As an idle roller is mounted on a guide for slidingly guiding the cover, sliding friction is reduced, and thus the cover can be opened or closed more stably.

(6) Further, since the guide is supported and prevented from suddenly sliding using the elastic support member and the damper, the cover gradually progresses from a cover-mounted position to protrude outward from the cover-mounted position so as to rotate, and thus can be used with confidence.

(7) Further, since the cover is maintained in a closed state using a push latch, the cover can be maintained in a locked state or unlocked state through a simple operation of pressing the cover with a hand or the like, and thus the device can be easily and conveniently used.

What is claimed is:

1. A cover opening and closing device comprising:
a support block having a guide hole and a mounting hole formed therein;
a rotation support part mounted in the guide hole;
a push latch installed in the mounting hole; and
a cover is rotated by being supported by the rotation support part and has a stopper that is caught/released by the push latch,
wherein the rotation support part includes:
a guide that is fitted in the guide hole, slides in a longitudinal direction thereof, and has a reaction part pressed by a first rotation link, when the cover is closed and configured to provide an elastic force so that the first rotation link is bounced when the cover is opened;
the first rotation link that is installed in the guide so that one side thereof rotates in place, extends in the longitudinal direction and is long so as to be installed in close contact with the cover in a closed state, and has one side installed to be elastically supported by an elastic support member supported by the guide hole so as to rotate outside the guide hole;
a second rotation link that has one side installed in the middle of a length of the first rotation link to rotate in place and the other side installed in the cover to rotate in place and is installed to rotate in a direction opposite to the first rotation link based on a point at which the first rotation link is installed;
a third rotation link that has one side installed between a point at which the first rotation link is rotatably mounted on the guide and a point at which the second rotation link is installed to rotate in place and the other side installed in the cover to rotate in place and is installed to rotate in a direction opposite to the first rotation link based on a point at which the first rotation link is installed; and
a fourth rotation link that has one side installed in a central portion of the third rotation link to rotate in palace and the other side installed in the guide to rotate in place and is installed to rotate in the same direction as the first rotation link based on a point mounted on the guide so as to change a rotational direction of the third rotation link that rotates based on the first rotation link.

2. The cover opening and closing device of claim 1, wherein a guide groove is formed through the support block and is long to pass through the guide hole in the longitudinal direction, and
the guide is provided with at least one guide pin guided through the guide groove.

3. The cover opening and closing device of claim 1, wherein the guide has at least one idle roller that rolls in close contact with an inner surface of the guide hole.

4. The cover opening and closing device of claim 1, wherein the rotation support part is equipped with a damper that limits a sudden rotation of the first rotation link by performing a buffering operation in a direction opposite to an elastic direction of the elastic support member.

5. The cover opening and closing device of claim 1, wherein the fourth rotation link is mounted on the guide so as to be positioned further outward from a position that laterally deviates from a rotation center point of the first rotation link based on a direction in which the guide slides.

6. The cover opening and closing device of claim 1, wherein the rotation support part causes the cover to rotate in the angle of 90°˜110° from the close position.
